(19) United States
(12) Patent Application Publication
(10) Pub. No.: US 2014/0234577 A1
(43) Pub. Date: Aug. 21, 2014

(54) Plastic Card Prelaminate and Plastic Card Including a Phone Sticker

(71) Applicant: IDENTIVE GROUP, INC., Santa Ana, CA (US)

(72) Inventor: Werner Vogt, Remetschwil (CH)

(73) Assignee: IDENTIVE GROUP, INC., Santa Ana, CA (US)

(21) Appl. No.: 13/768,547

(22) Filed: Feb. 15, 2013

(51) Int. Cl. B32B 37/14; B32B 3/26

(52) U.S. Cl. CPC B32B 37/14; B32B 3/266
USPC 428/138; 156/293; 156/267

(57) ABSTRACT

A plastic card prelaminate and a plastic card including a phone sticker, and methods for manufacturing the same are described herein. A first plastic sheet is provided, having a release layer bonded to the first plastic sheet via an adhesive layer. At least one composite structure is provided, the composite structure including a plastic layer including at least one electronic element. A second plastic sheet is provided on top of the first plastic sheet. At least one through-hole is formed in the second plastic sheet, where each through-hole is smaller than the release layer bonded to the first plastic sheet. A composite structure is positioned in each through-hole.

### FIELD OF THE INVENTION

The subject matter of this application relates generally to a plastic card prelaminate and a plastic card including a phone sticker, and methods for manufacturing the same.

### BACKGROUND OF THE INVENTION

Stickers for mobile phones provided by original equipment manufacturers (OEM) may include radio frequency identification (RFID) chips or near field (NFC) communication chips to allow the mobile phone to be used in the fields of private payment, transportation, loyalty, access and others. Some RFID phone stickers are provided as part of a plastic card and may be punched out for placement on a mobile phone. Typically, such plastic cards are produced by a card manufacturer and may be personalized by the OEM.

One type of phone sticker consists of a composite material comprising a liner, an adhesive layer, a ferrite layer, an inlay layer including an RFID antenna, and a top label. This phone sticker is applied in the cavity of a card carrier and associated to the card carrier by in-mold lamination. However, delamination problems can be experienced on these types of plastic cards that result in undesirable visual aspects. For example, U.S. Patent Application Publication No. 2011/0062243 A1 to Heusmann et al. discloses a phone sticker where the composite is stuck in the cavity of a card carrier and reversibly fixed via a transport film and an underlay. The occurrence of delamination and related problems are expected for this card type.

Another type of plastic card is made from a prelaminate comprising an inlay including an RFID antenna and a ferrite layer that is laminated to a polyvinyl chloride layer on both sides. After personalization, an optional aluminum foil, an adhesive layer and a liner are placed underneath the card. However, this results in a thick and rigid sticker.

Several further types of rigid phone stickers are known, each with a thickness of at least 640 μm.

Another method of producing a plastic card with a RFID phone sticker comprises making a standard RFID card and, once the RFID card is detached, sliding the card into a housing that contains a ferrite layer, an adhesive and a liner. That method is expensive and also results in a rigid sticker.

Due to the above-mentioned problems of plastic cards including RFID phone stickers, some manufacturers are delivering phone stickers on reels or singulated, i.e., not in a card format or construction. These stickers are thin and flexible for use as phone stickers, but they are not compatible for use with standard personalization machines.

### SUMMARY OF THE INVENTION

Therefore, what is needed is a method for making a plastic card including a phone sticker or a metal-compatible contactless sticker that is sufficiently thin and flexible but can be provided in a personalized plastic card.

This objective is achieved by a method for manufacturing a plastic card prelaminate, the method comprising providing a first plastic sheet having a release layer bonded to the first plastic sheet via an adhesive layer, providing at least one composite structure comprising a plastic layer including at least one electronic element, providing a second plastic sheet on top of the first plastic sheet, forming at least one through-hole in the second plastic sheet, where each through-hole is smaller than the release layer bonded to the first plastic sheet, and positioning one composite structure in each through-hole.

The plastic layer can comprise a transparent material to allow the electronic element to be seen from top of the prelaminate. Preferably the adhesive layer comprises a pressure sensitive adhesive (PSA) to allow optimal use of the sticker. The composite structure can include an absorber layer, preferably comprised of a material that reduces Eddy currents (also called Foucault currents), to shield the electronic element from the electronic components of a mobile phone when a mobile phone sticker comprising the prelaminate is placed on the mobile phone.

The release layer affects adhesion between the plastic layer and the first plastic sheet to allow easy separation of said materials. The release layer preferably comprises materials of a non-adhesive nature silicone, Teflon or similar types of materials. Moreover, the release layer is preferably coated on the first plastic sheet via screen printing. These techniques allow a thin release layer that is thinner than traditional release layers, e.g., paper layers. The release layer can also be a polymer layer, such as polyester.

To personalize said plastic card, the first plastic sheet is printed and the printed side of the first plastic sheet is positioned adjacent to the plastic layer of the plastic card prelaminate. This allows the printing to be protected from damage by the first plastic sheet.

The invention, in one aspect, features a method for manufacturing a plastic card prelaminate. A first plastic sheet having a release layer bonded to the first plastic sheet via an adhesive layer is provided. At least one composite structure is provided, the composite structure including a plastic layer including at least one electronic element. A second plastic sheet is provided on top of the first plastic sheet. At least one through-hole is formed in the second plastic sheet, where each through-hole is smaller than the release layer bonded to the first plastic sheet. A composite structure is positioned in each through-hole.

The invention, in another aspect, features a plastic card prelaminate. The plastic card prelaminate includes a first plastic sheet having a release layer bonded to the first plastic sheet via an adhesive layer, and a second plastic sheet on top of the first plastic sheet. The plastic card prelaminate further includes at least one composite structure in at least one through-hole in the second plastic sheet. The composite structure includes a plastic layer including at least one electronic element, where each through-hole is smaller than the release layer bonded to the first plastic sheet.

The invention, in another aspect, features a method for manufacturing a plastic card. A plastic card prelaminate is provided, the plastic card prelaminate including a first plastic sheet having a release layer bonded to the first plastic sheet via an adhesive layer, and a second plastic sheet on top of the first plastic sheet. The plastic card prelaminate further includes at least one composite structure in at least one through-hole in the second plastic sheet. The composite structure includes a plastic layer including at least one electronic element, where each through-hole is smaller than the release layer bonded to the first plastic sheet. A third plastic sheet is positioned adjacent to the plastic layer and the second plastic sheet. A fourth plastic sheet is positioned adjacent to the first plastic sheet. The first plastic sheet, the second plastic sheet, the composite structure, the third plastic sheet and the fourth plastic sheet are laminated to obtain a laminated sheet. The plastic card is cut from the laminated sheet.

The invention, in another aspect, features a plastic card. The plastic card includes plastic card prelaminate. The plastic card prelaminate includes a first plastic sheet having a release layer bonded to the first plastic sheet via an adhesive layer, and a second plastic sheet on top of the first plastic sheet. The plastic card prelaminate further includes at least one composite structure in at least one through-hole in the second plastic sheet. The composite structure includes a plastic layer including at least one electronic element, where each through-hole is smaller than the release layer bonded to the first plastic sheet. The plastic card includes a third plastic sheet positioned adjacent to the plastic layer and the second plastic sheet. The plastic card includes a fourth plastic sheet positioned adjacent to the first plastic sheet. The first plastic sheet, the second plastic sheet, the composite structure, the third plastic sheet and the fourth plastic sheet are laminated to obtain a laminated sheet. The plastic card is cut from the laminated sheet.

In some embodiments, any of the above aspects can include one or more of the following features. In some embodiments, each of the plastic layer, the first plastic sheet and the second plastic sheet comprises a material selected from the group consisting of polyvinyl chloride (PVC), polyethylene terephthalate (PET/PETE), polyester (PE) and acrylonitrile-butadiene-styrene (ABS). In some embodiments, the plastic layer consists of a transparent material. In some embodiments, the electronic element is a radio frequency identification (RFID) chip and antenna or a near field communication (NFC) chip and antenna.

In some embodiments, the adhesive layer comprises a pressure sensitive adhesive. In some embodiments, the composite structure includes an absorber layer positioned below the plastic layer and comprising a material that reduces Eddy currents. In some embodiments, the material that reduces Eddy currents is a magnetically soft and/or high permeable material selected from the group consisting of rare earth metals, ferrites, cobalt/neodymium compounds and combinations thereof In some embodiments, the material that reduces Eddy currents is applied to the plastic layer via screen printing.

In some embodiments, the composite structure includes a first cover layer positioned on top of the plastic layer and comprising a unidirectional thermally expansive material, and a second cover layer positioned below the plastic layer and comprising the unidirectional thermally expansive material. In some embodiments, the release layer comprises a material selected from the group consisting of silicones and Teflon.

In some embodiments, one surface of the first plastic sheet is coated with the release layer via screen printing. In some embodiments, the adhesive force between the adhesive layer and the release layer is greater than the adhesive force between the plastic layer and the release layer. In some embodiments, the composite structure includes the release layer.

In some embodiments, the composite structure includes a contact adhesive layer positioned below the plastic layer. In some embodiments, a third plastic sheet is positioned between the plastic layer and the release layer.

In some embodiments, the plastic card is pre-cut in an area defining a phone sticker or a metal-compatible contactless sticker. In some embodiments, the phone sticker is surrounded by a pre-cut area, all plastic card material is removed in a first part of the pre-cut area, and a second part of the pre-cut area comprises at least one cut-line extending from the fourth plastic layer to the release layer. In some embodiments, the second pre-cut area comprises two cut-lines. In some embodiments, a phone sticker is obtainable by separating the phone sticker from the plastic card.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1A shows a cross-sectional view of a plastic card prelaminate according to an embodiment of the invention.

FIG. 1B shows a cross-sectional view of a laminated sheet produced from the plastic card prelaminate according to FIG. 1A.

FIG. 2A shows a cross-sectional view of a plastic card prelaminate according to an embodiment of the invention.

FIG. 2B shows a cross-sectional view of a laminated sheet produced from the plastic card prelaminate according to FIG. 2A.

FIGS. 3A-3B show cross-sectional views of composite structures according to embodiments of the invention.

FIG. 4A shows a cross-sectional view of a plastic card prelaminate according to an embodiment of the invention.

FIG. 4B shows a cross-sectional view of a laminated sheet produced from the plastic card prelaminate according to FIG. 4A.

FIG. 5A shows a cross-sectional view of a plastic card prelaminate according to an embodiment of the invention.

FIG. 5B shows a cross-sectional view of a laminated sheet produced from the plastic card prelaminate according to FIG. 5A.

FIGS. 6A-6B show cross-sectional views of composite structures according to embodiments of the invention.

FIGS. 7A-7D show cross-sectional views of plastic card prelaminates with an additional plastic sheet according to embodiments of the invention.

FIG. 8A shows a cross-sectional view of a plastic card prelaminate according to an embodiment of the invention.

FIG. 8B shows a cross-sectional view of a laminated sheet produced from the plastic card prelaminate according to FIG. 8A.

FIG. 9A shows a cross-sectional view of a plastic card prelaminate according to an embodiment of the invention.

FIG. 9B shows a cross-sectional view of a laminated sheet produced from the plastic card prelaminate according to FIG. 8A.

FIGS. 10-11 show top views of plastic cards according to embodiments of the invention.

### DETAILED DESCRIPTION

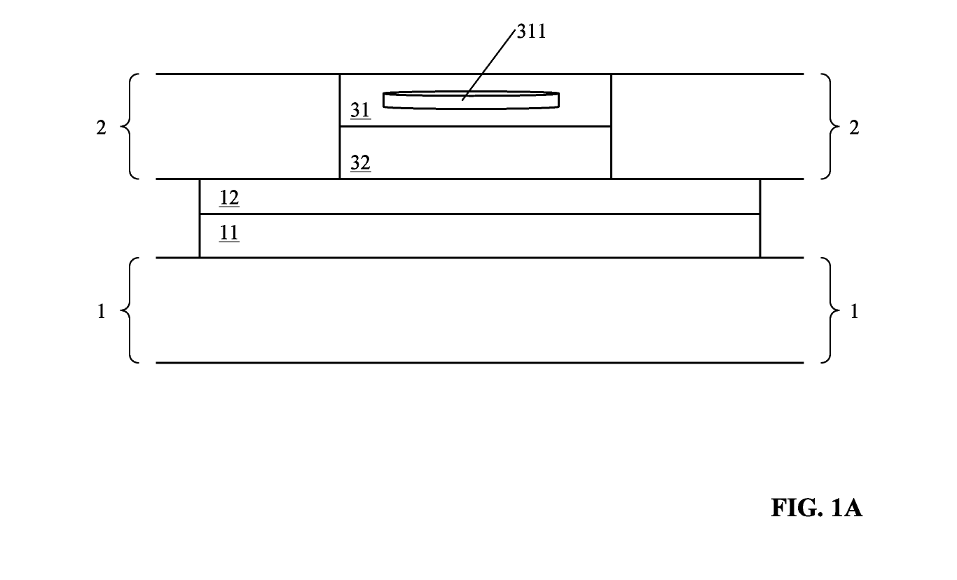

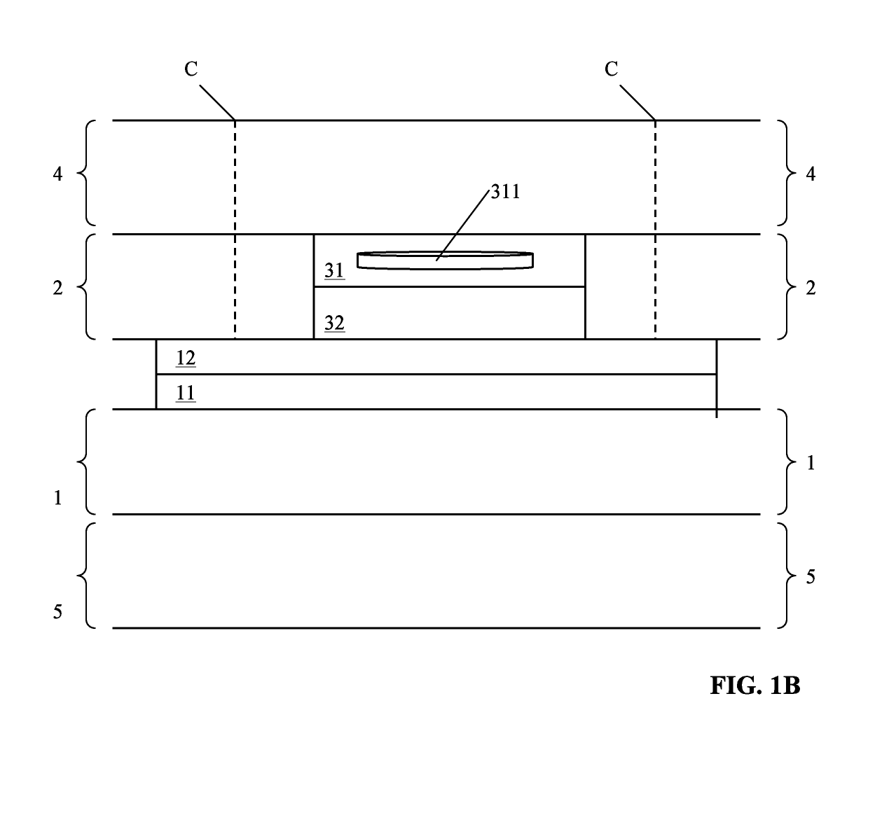

FIG. 1A shows a cross-sectional view of a plastic card prelaminate produced by a method according to an embodiment of the invention. A first PVC sheet 1 is partly covered with an adhesive layer 11. A release layer 12 comprising, e.g., polyester, is adhered to the adhesive layer 11. Several through-holes are formed in a second PVC sheet 2 and the second PVC sheet 2 is placed on the release layer 12 so that each through-hole is covered by the release layer 12. Composite structures are produced by adhering an inlay 31 on the release layer 12 using a contact adhesive layer 32.

The inlay 31 comprises a polyester layer (e.g., Melinex® by DuPont Teijin Films, USA) and includes an RFID chip and antenna 311. A composite structure is placed in each through-hole, and the contact adhesive layer 32 is placed on top of the release layer 12.

To manufacture plastic cards from the plastic card prelaminate and to personalize the card, a third PVC sheet 4 is printed on one side and the printed side of said PVC sheet 4 is placed adjacent to the inlay 31 of the plastic card prelaminate, as shown in FIG. 1B. A fourth PVC sheet 5 is placed adjacent to the first PVC sheet 1. The third PVC sheet 4, the fourth PVC sheet 5 and the plastic card prelaminate including the composite structures, the second PVC sheet 2, the release layer 12, the adhesive layer 11 and the first PVC sheet 1 are laminated. Any standard laminating techniques known in the art can be used, resulting in a laminated sheet that has a thickness of 0.76±0.08 mm.

Plastic cards are cut from the resulting laminated sheet so that each plastic card contains one RFID chip and antenna 311. Each resulting plastic card is pre-cut along cut lines C in an area outside the composite structure but cutting through the third PVC sheet 4 and the second PVC sheet 2 to define a phone sticker. The cut lines can be formed by different methods of cutting, including but not limited to use of a blade or knife edge (e.g., stamp knife cutting). In some embodiments, the cut lines are formed by milling the laminated sheet. It should be appreciated that other cutting techniques and methods can be used without departing from the spirit and scope of the invention.

A user can separate the phone sticker from the plastic card. The adhesive force between the adhesive layer 11 and the release layer 12 is greater than the adhesive force between the contact adhesive layer 32 and the release layer 12. To stick the phone sticker on a mobile phone, the user can separate the phone sticker from the release layer 12 and the first PVC sheet 1, so that the contact adhesive layer 32 may be placed on top of the mobile phone housing.

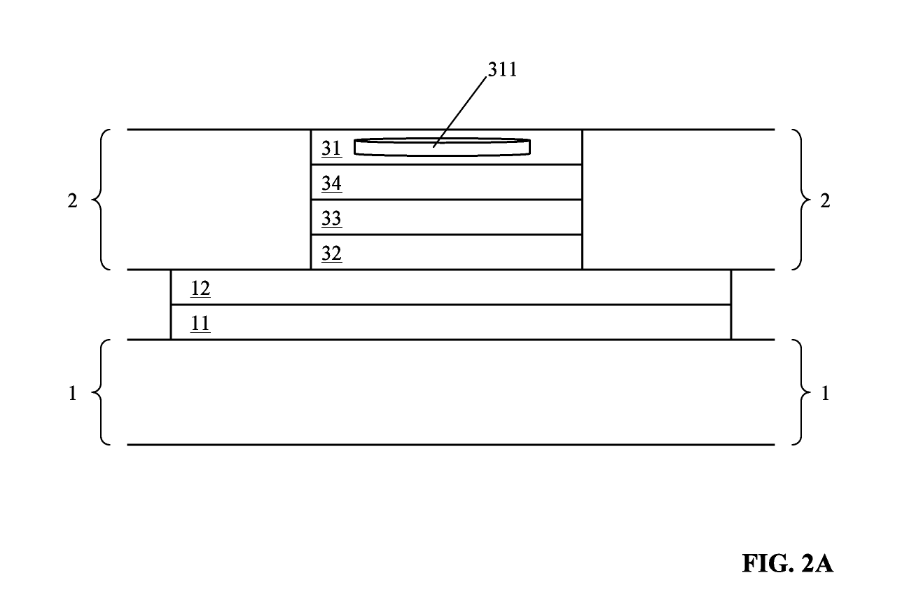

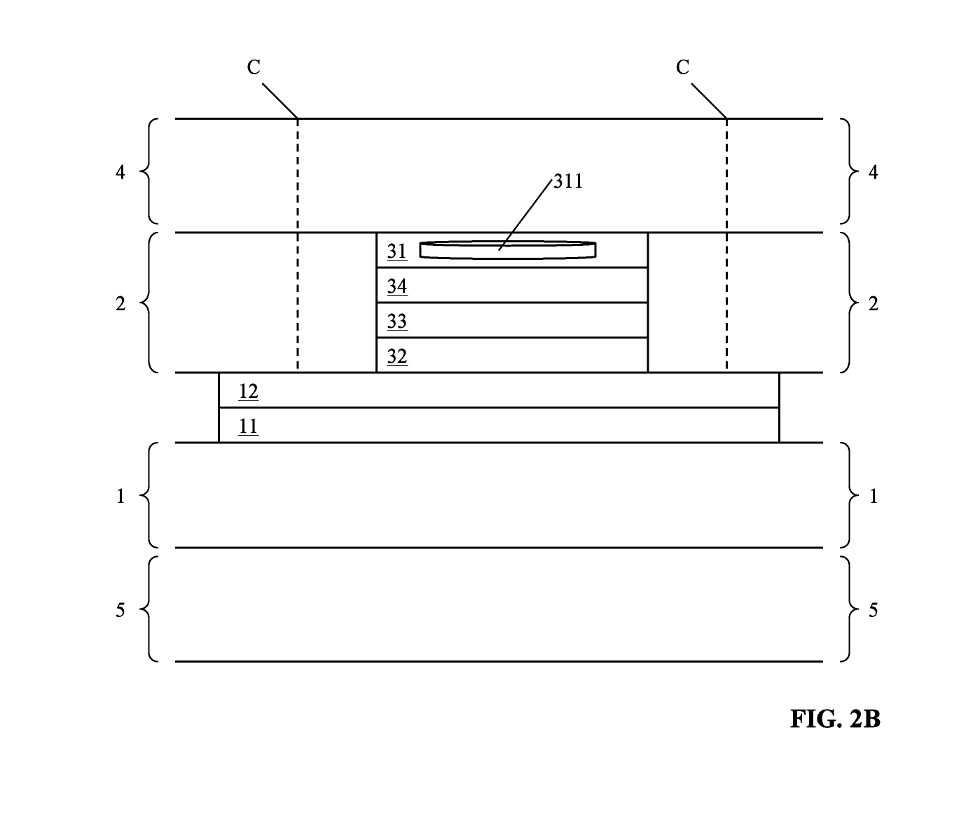

FIG. 2A shows a cross-sectional view of a plastic card prelaminate produced by a method according to an embodiment of the invention. A first PVC sheet 1 is partly covered with an adhesive layer 11. A release layer 12 comprising, e.g., polyester, is adhered to the adhesive layer 11. Several through-holes are formed in a second PVC sheet 2 and the second PVC sheet 2 is placed on the release layer 12 so that each through-hole is covered by the release layer 12. Composite structures in the second embodiment are produced by adhering an inlay 31 on an absorber layer 33 using an interface adhesive layer 32. A contact adhesive layer 34 is then placed on the absorber layer 33. The absorber layer 33 is comprised of a material that reduces Eddy currents. In some embodiments, the material that reduces Eddy currents is a magnetically soft and/or high permeable material selected from the group consisting of rare earth metals, ferrites, cobalt/neodymium compounds and combinations thereof The inlay 31 comprises a polyester layer (e.g., Melinex® by DuPont Teijin Films, USA) and includes an RFID chip and antenna 311. A composite structure is placed in each through-hole, and the contact adhesive layer 34 of the composite structure is placed on top of the release layer 12.

To manufacture plastic cards from the plastic card prelaminate and to personalize the card, a third PVC sheet 4 is printed on one side and the printed side of said PVC sheet 4 is placed adjacent to the inlays 31 of the plastic card prelaminate, as shown in FIG. 2B. A fourth PVC sheet 5 is placed adjacent to the first PVC sheet 1. The third PVC sheet 4, the fourth PVC sheet 5 and the plastic card prelaminate including the composite structures, the second PVC sheet 2, the release layer 12, the adhesive layer 11 and the first PVC sheet 1 are laminated. Any standard laminating techniques known in the art can be used, resulting in a laminated sheet that has a thickness of 0.76±0.08 mm.

Plastic cards are cut from the resulting laminated sheet so that each plastic card contains one RFID chip and antenna 311. Each resulting plastic card is pre-cut along cut lines C in an area outside the composite structure but cutting through the third PVC sheet 4 and the second PVC sheet 2 to define a phone sticker. The cut lines can be formed by different methods of cutting, including but not limited to use of a blade or knife edge (e.g., stamp knife cutting). In some embodiments, the cut lines are formed by milling the laminated sheet. It should be appreciated that other cutting techniques and methods can be used without departing from the spirit and scope of the invention.

A user can separate the phone sticker from the plastic card. The adhesive force between the adhesive layer 11 and the release layer 12 is greater than the adhesive force between the contact adhesive layer 32 and the release layer 12. To stick the phone sticker on a mobile phone, the user can separate the phone sticker from the release layer 12 and the first PVC sheet 1, so that the contact adhesive layer 32 may be placed on top of the mobile phone housing.

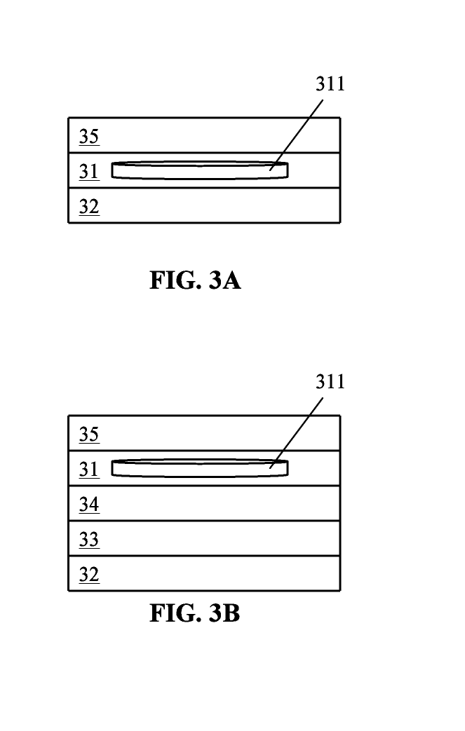

In any of the embodiments described herein, the composite structure can be provided in additional configurations without departing from the scope of the invention. As shown in FIG. 3A, in one embodiment, the composite structure is produced by adhering an inlay 31 on a contact adhesive layer 32, and a topfoil layer 35 is placed on top of the inlay 31. As shown in FIG. 3B, in another embodiment, the composite structure is produced by adhering an inlay 31 on an absorber layer 33 using an interface adhesive layer 34. A topfoil layer 35 is placed on top of the inlay 31, and a contact adhesive layer 32 is placed on the absorber layer 33.

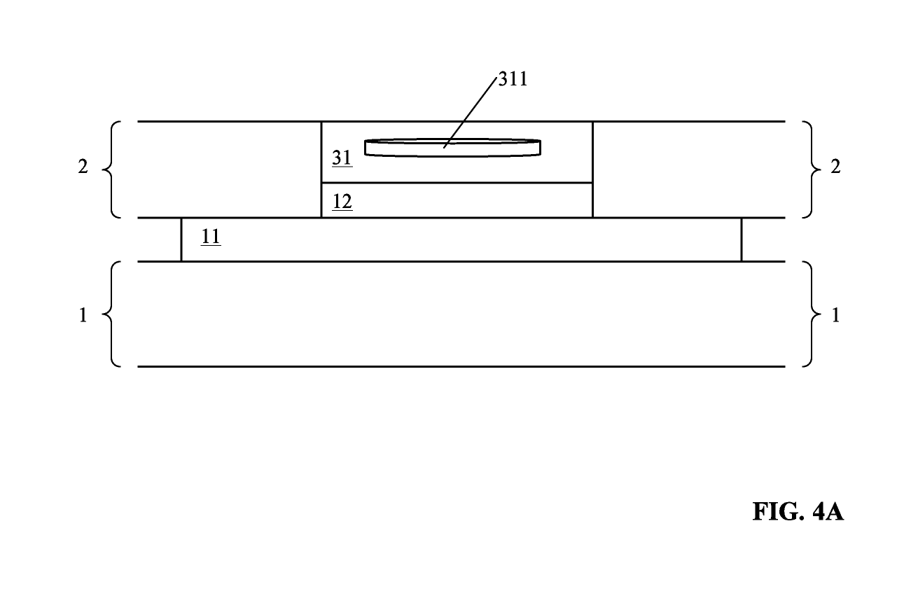

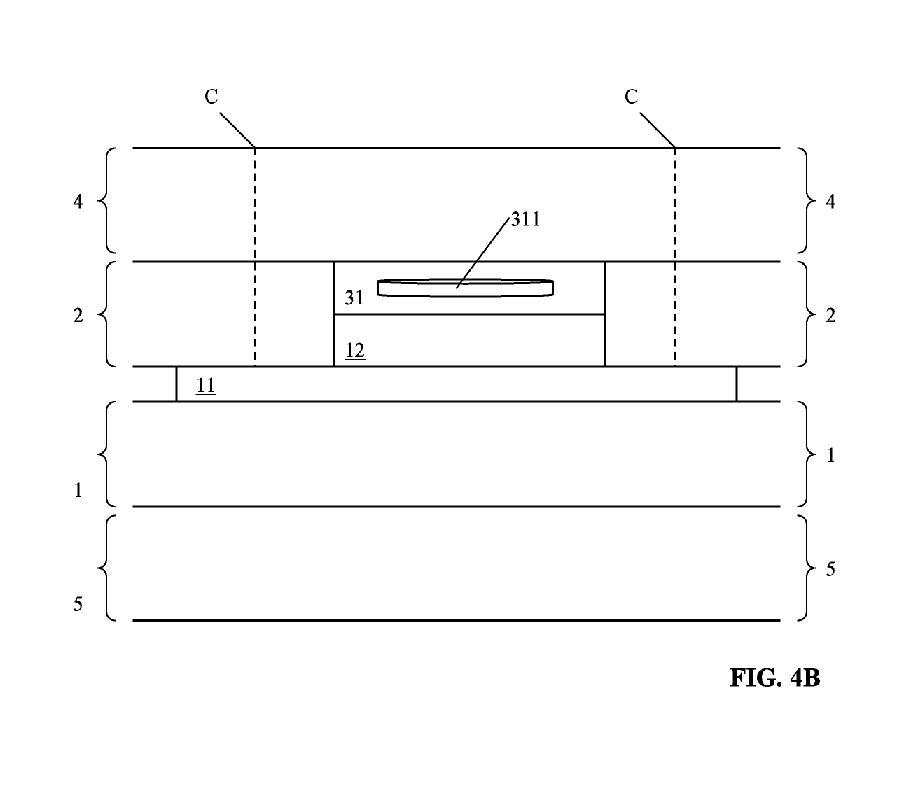

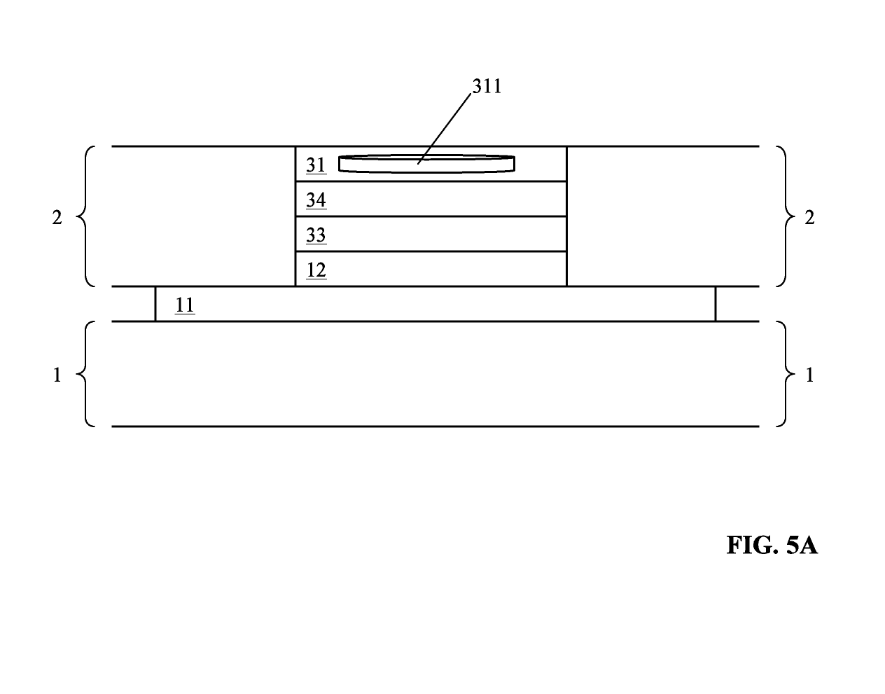

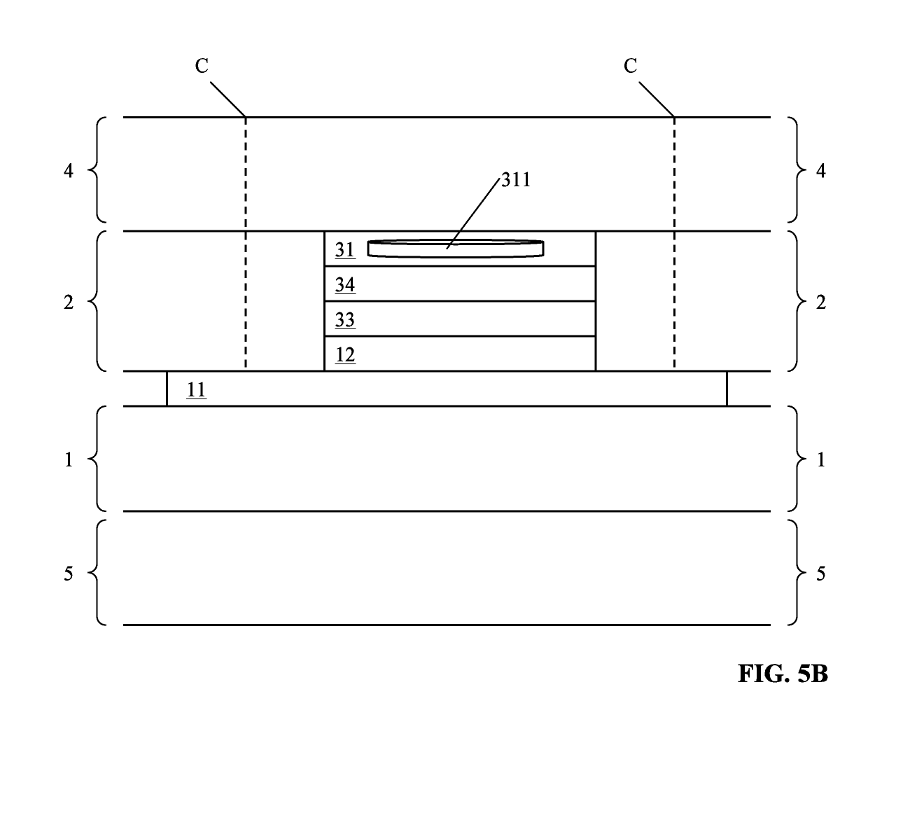

In addition, any of the embodiments described herein can include a ‘dry’ composite structure—meaning that when the composite structure is separated from the first PVC sheet, the structure does not have a contact adhesive layer (or the like) to affix the structure to a mobile device housing. In these embodiments, the release layer is adhered to the composite structure instead of to the first PVC sheet. FIGS. 4A-4B and 5A-5B show cross-sectional views of a plastic card prelaminate that result in a dry composite structure.

FIG. 4A shows a cross-sectional view of a plastic card prelaminate produced by a method according to an embodiment of the invention. A first PVC sheet 1 is partly covered with an adhesive layer 11. Several through-holes are formed in a second PVC sheet 2 and the second PVC sheet 2 is placed on the first PVC sheet 1. A composite structure is placed in each through-hole. The composite structures are produced by adhering an inlay 31 on a release layer 12. The inlay 31 comprises a polyester layer (e.g., Melinex® by DuPont Teijin Films, USA) and includes an RFID chip and antenna 311. The release layer 12 is placed on top of the adhesive layer 11.

To manufacture plastic cards from the plastic card prelaminate and to personalize the card, a third PVC sheet 4 is printed on one side and the printed side of said PVC sheet 4 is placed adjacent to the inlay 31 of the plastic card prelaminate, as shown in FIG. 4B. A fourth PVC sheet 5 is placed adjacent to the first PVC sheet 1. The third PVC sheet 4, the fourth PVC sheet 5 and the plastic card prelaminate including the composite structures, the second PVC sheet 2, the adhesive layer 11 and the first PVC sheet 1 are laminated. Any standard laminating techniques known in the art can be used, resulting in a laminated sheet that has a thickness of 0.76±0.08 mm.

Plastic cards are cut from the resulting laminated sheet so that each plastic card contains one RFID chip and antenna 311. Each resulting plastic card is pre-cut along cut lines C in an area outside the composite structure but cutting through the third PVC sheet 4 and the second PVC sheet 2 to define a phone sticker.

A user can separate the phone sticker from the plastic card. The adhesive force between the adhesive layer 11 and the release layer 12 is greater than the adhesive force between the inlay 31 and the release layer 12. Thus, the release layer 12 of the composite structure adheres to the adhesive layer 11 upon separating the structure from the first PVC sheet 1. As a result, the composite structure is dry and does not include an adhesive layer to affix the structure to another surface.

FIG. 5A shows a cross-sectional view of a plastic card prelaminate produced by a method according to another embodiment of the invention. A first PVC sheet 1 is partly covered with an adhesive layer 11. Several through-holes are formed in a second PVC sheet 2 and the second PVC sheet 2 is placed on the first PVC sheet 1. Composite structures are produced by adhering an inlay 31 on an absorber layer 33 using an interface adhesive layer 34. A release layer 12 is then placed on the absorber layer 33. The absorber layer 33 is comprised of a material that reduces Eddy currents. The inlay 31 comprises a polyester layer (e.g., Melinex® by DuPont Teijin Films, USA) and includes an RFID chip and antenna 311. A composite structure is placed in each through-hole, and the release layer 12 of the composite structure is placed on top of the adhesive layer 11.

To manufacture plastic cards from the plastic card prelaminate and to personalize the card, a third PVC sheet 4 is printed on one side and the printed side of said PVC sheet 4 is placed adjacent to the inlays 31 of the plastic card prelaminate, as shown in FIG. 5B. A fourth PVC sheet 5 is placed adjacent to the first PVC sheet 1. The third PVC sheet 4, the fourth PVC sheet 5 and the plastic card prelaminate including the composite structures, the second PVC sheet 2, the adhesive layer 11 and the first PVC sheet 1 are laminated. Any standard laminating techniques known in the art can be used, resulting in a laminated sheet that has a thickness of 0.76±0.08 mm.

Plastic cards are cut from the resulting laminated sheet so that each plastic card contains one RFID chip and antenna 311. Each resulting plastic card is pre-cut along cut lines C in an area outside the composite structure but cutting through the third PVC sheet 4 and the second PVC sheet 2 to define a phone sticker.

A user can separate the phone sticker from the plastic card. The adhesive force between the adhesive layer 11 and the release layer 12 is greater than the adhesive force between the absorber layer 33 and the release layer 12. Thus, the release layer 12 of the composite structure adheres to the adhesive layer 11 upon separating the structure from the first PVC sheet 1. As a result, the composite structure is dry and does not include an adhesive layer to affix the structure to another surface.

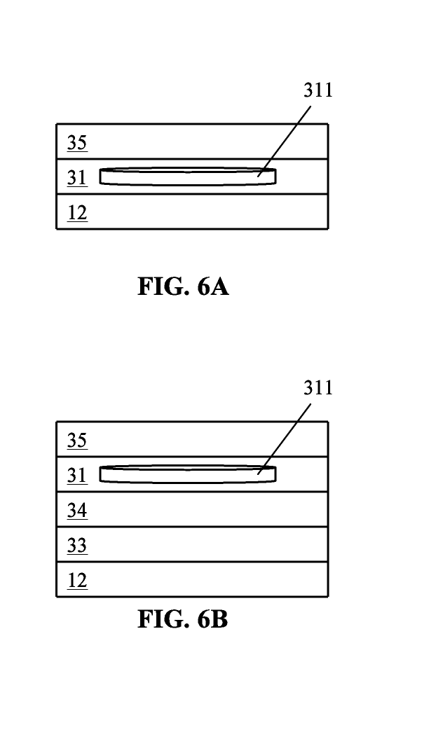

In any of the embodiments described herein, the composite structure can be provided in additional configurations without departing from the scope of the invention. As shown in FIG. 6A, in one embodiment, the composite structure is produced by adhering an inlay 31 on a release layer 12, and a topfoil layer 35 is placed on top of the inlay. As shown in FIG. 6B, in another embodiment, the composite structure is produced by adhering an inlay 31 on an absorber layer 33 using an interface adhesive layer 34. A topfoil layer 35 is placed on top of the inlay 31, and a release layer 12 is placed on the absorber layer 33. Each of these embodiments results in a dry composite structure because the release layer stays affixed to the first PVC sheet when separating the structure from the sheet.

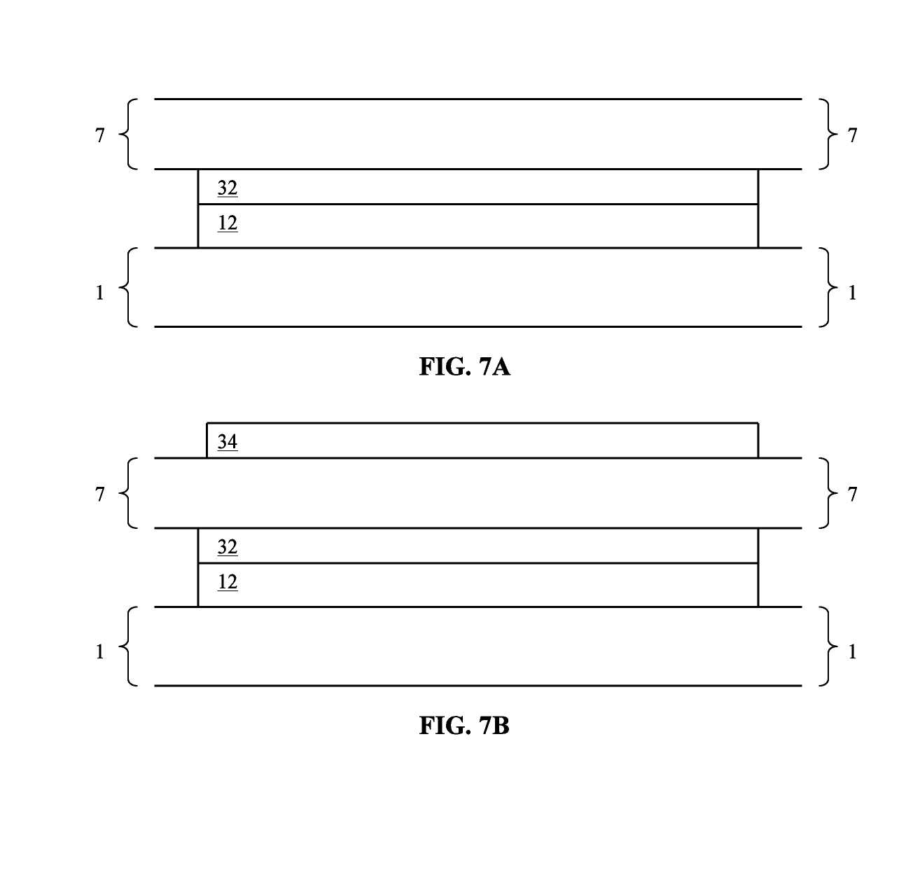

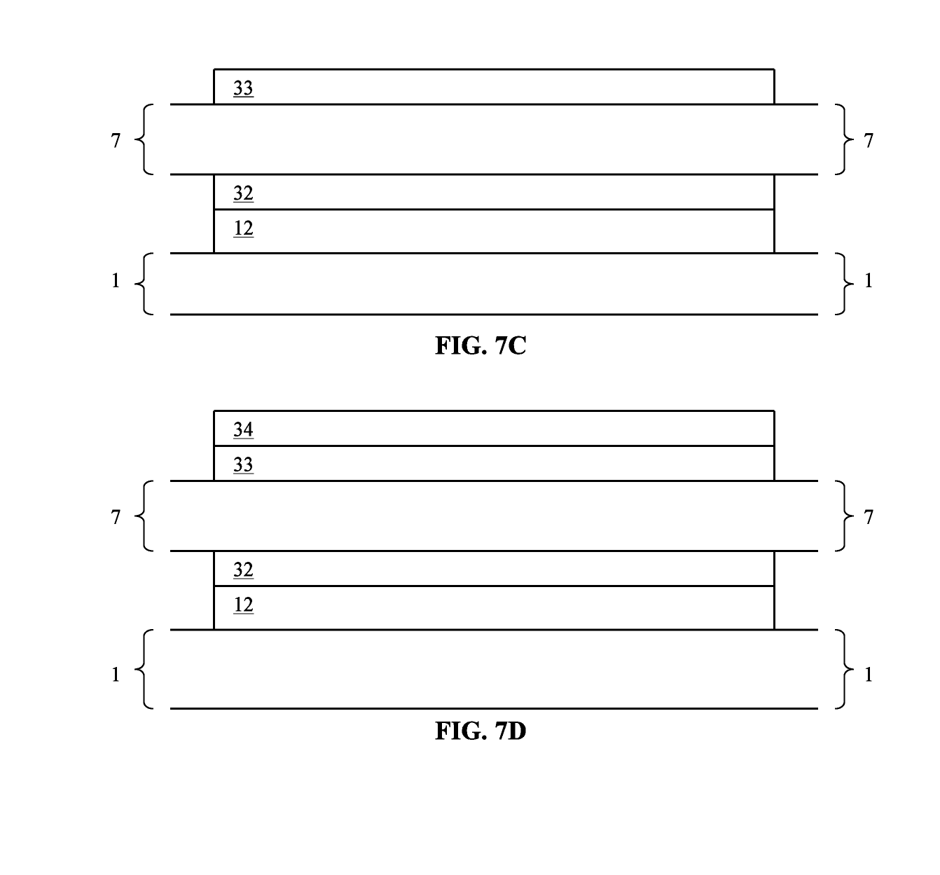

Further, any of the embodiments described herein can include an additional PVC sheet that is adhered to the first PVC sheet to minimize deformation, warping, and/or bending of the resultant card and phone sticker. FIGS. 7A-7D show cross-sectional views of plastic card prelaminates that include an additional PVC sheet as part of the construction.

In FIG. 7A, a release layer 12 is affixed to a first PVC sheet 1, and an additional PVC sheet 7 having a contact adhesive layer 32 is applied to the first PVC sheet 1. In FIG. 7B, a release layer 12 is affixed to a first PVC sheet 1, an additional PVC sheet 7 having a contact adhesive layer 32 is applied to the first PVC sheet 1, and an interface adhesive layer 34 is applied to the additional PVC sheet. In FIG. 7C, a release layer 12 is affixed to a first PVC sheet 1, an additional PVC sheet 7 having a contact adhesive layer 32 is applied to the first PVC sheet 1, and an absorber layer 33 is applied to the additional PVC sheet 7. In FIG. 7D, a release layer 12 is affixed to a first PVC sheet 1, an additional PVC sheet 7 having a contact adhesive layer 32 is applied to the first PVC sheet 1, an absorber layer 33 is applied to the additional PVC sheet 7, and an interface adhesive layer 34 is applied to the absorber layer 33.

As described previously, the second PVC sheet with through-holes and composite structures can be placed on top of the additional PVC sheet in any of the above embodiments to create a plastic card prelaminate.

In some embodiments, the possibility exists of gaps or empty spaces being present in the composite structure caused by the chip recess and/or the conductors (e.g., antenna tracks) on the antenna assembly. These gaps or spaces can cause small undulations on the surface of the composite structure that, when laminated into a finished card, can still be seen. Such artifacts are considered undesirable and detract from the quality of both the card and the composite structure. In addition, thermal printing processes typically require an extremely flat surface to make uniform colors. If the surface is not flat, a blemish can be seen on a card after printing.

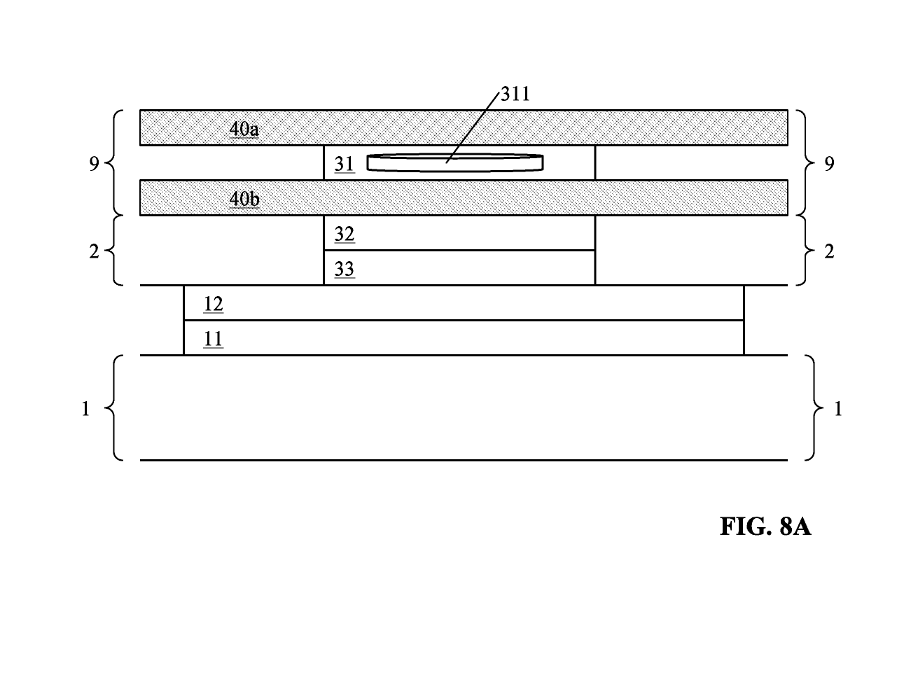

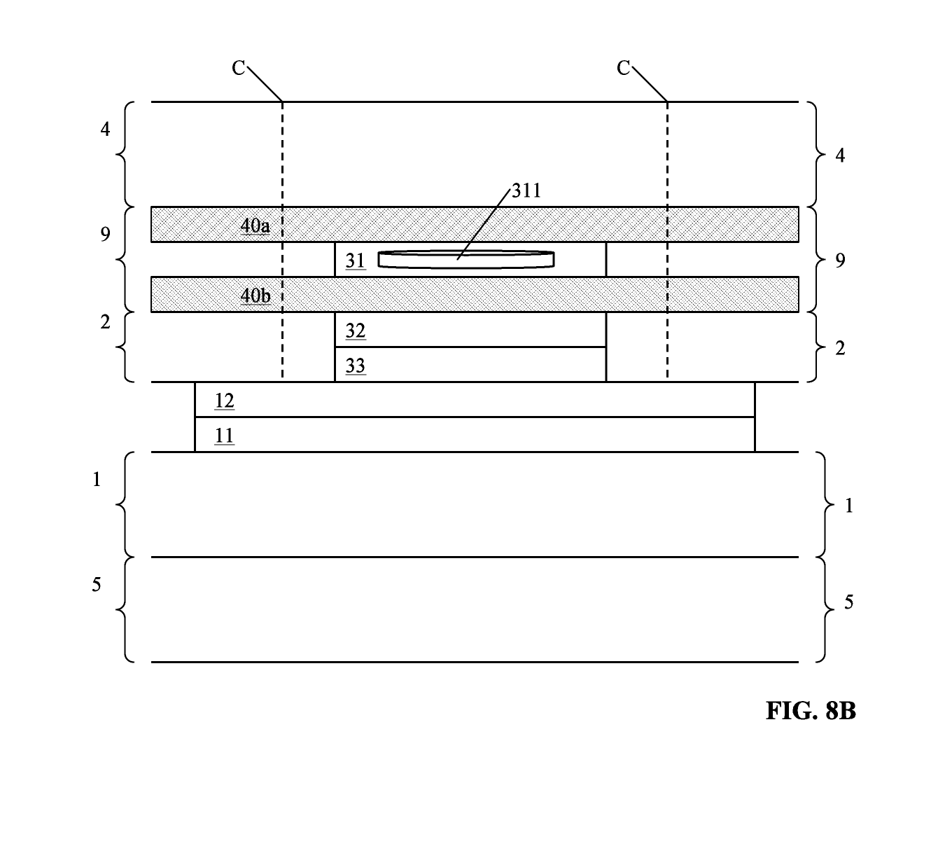

FIG. 8A shows a cross-sectional view of a plastic card prelaminate produced by a method according to an embodiment of the invention. A first PVC sheet 1 is partly covered with an adhesive layer 11. A release layer 12 comprising, e.g., polyester, is adhered to the adhesive layer 11. Several through-holes are formed in a second PVC sheet 2 and the second PVC sheet 2 is placed on the release layer 12 so that each through-hole is covered by the release layer 12.

The composite structure includes an inlay 31. The inlay 31 comprises a polyester layer (e.g., Melinex® by DuPont Teijin Films, USA) and includes an RFID chip and antenna 311. The inlay 31 is included in a sheet 9 having two cover layers 40a and 40b of a unidirectional thermally expansive material positioned on the top and the bottom of the inlay 31. The sheet 9 is placed on top of the second PVC sheet 2.

When the unidirectional thermally expansive material is heated, it expands and can fill up the gaps and/or spaces that form between the inlay 31 and other adjacent layers. In some embodiments, the trigger temperature for the thermally expansive material is selectable. When the unidirectional thermally expansive material is cooled after it is heated, the material generally maintains its volume (although the volume may decrease slightly—e.g., less than 5%). The term “unidirectional” refers to the characteristic of the material in which it does not return to its original volume upon cooling from a higher temperature. In addition, the material can create a strong bond with polyester and similar materials, from which etched inlays can be constructed. When the lamination process is complete, the unidirectional thermally expansive material is solid and forms part of the composite structure. The unidirectional thermally expansive material is benign and does not interfere with the operation of the composite structure, the inlay, or the card structure.

In some embodiments, the unidirectional thermally expansive coating material includes at least 60% of polyurethane polymers, at least 0.1% of acrylic copolymers, and at least 0.1% of hydrocarbons (e.g., isobutane and/or isopentane). In some embodiments, the unidirectional thermally expansive coating material includes 80-98% of polyurethane polymers and 20%-2% of acrylic copolymers and hydrocarbons. The polyurethane polymer can include aliphatic polyurethane surfactants free to formulate thermal activated adhesives. The polyurethane polymer can be in a waterborne dispersion. The tensile strength of the coating material can be 5 MPa and/or can include an elongation factor of 550-650%.

In some embodiments, the polyurethane polymer can include ESABOND DP 11 manufactured by Lamberti Chemical Specialties Co., Ltd. of Shanghai, China. The acrylic copolymers and hydrocarbons can include thermo-expandable microcapsules that encapsulate volatile hydrocarbons with acrylic copolymers. The average particle size of microcapsules can be between 6 and 12 um. The chemical composition of the microcapsules can include a shell (acrylonitrile-copolymer) and a core (isobutene). In some embodiments, expansion of the particles can begin at between 80° and 90° Celsius and end expansion between 110° and 120° Celsius. In some embodiments, the coating material can be heated above the temperature trigger point for between 2 and 4 minutes. The acrylic copolymers and hydrocarbons can include Micropearl F-36 manufactured by Lehmann & Voss & Co. of Hamburg, Germany.

To manufacture plastic cards from the plastic card prelaminate and to personalize the card, a third PVC sheet 4 is printed on one side and the printed side of said PVC sheet 4 is placed adjacent to the sheet 9 and cover layer 40a of the plastic card prelaminate, as shown in FIG. 8B. A fourth PVC sheet 5 is placed adjacent to the first PVC sheet 1. The third PVC sheet 4, the fourth PVC sheet 5 and the plastic card prelaminate including the sheet 9, the second PVC sheet 2, the release layer 12, the adhesive layer 11 and the first PVC sheet 1 are laminated. Any standard laminating techniques known in the art can be used, resulting in a laminated sheet that has a thickness of 0.76±0.08 mm.

Plastic cards are cut from the resulting laminated sheet so that each plastic card contains one RFID chip and antenna 311. Each resulting plastic card is pre-cut along cut lines C in an area outside the inlay 31 but cutting through the cover layers 40a and 40b, the third PVC sheet 4 and the second PVC sheet 2 to define a phone sticker.

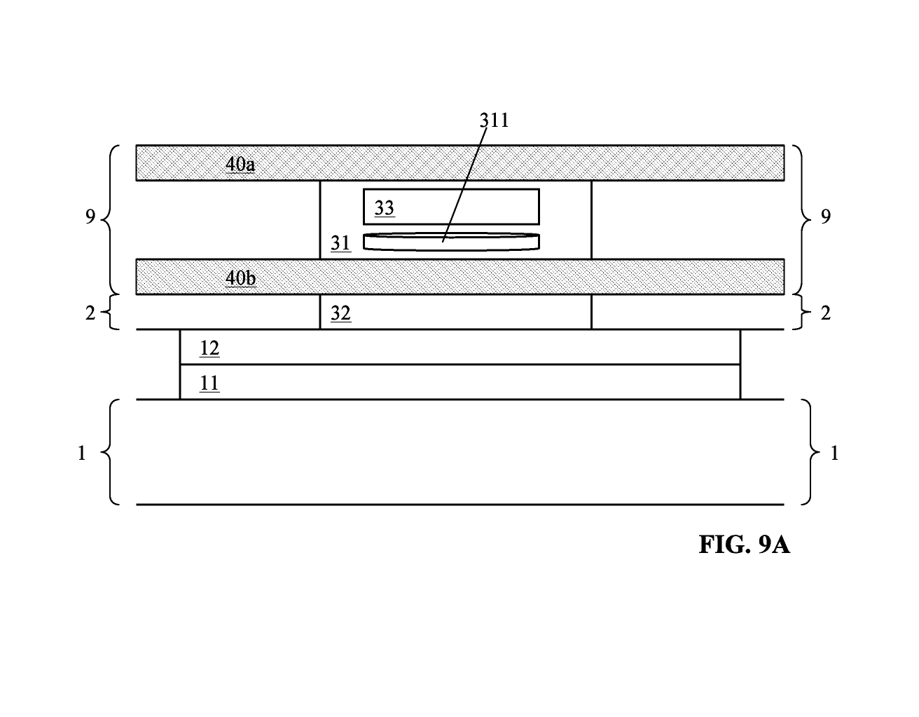

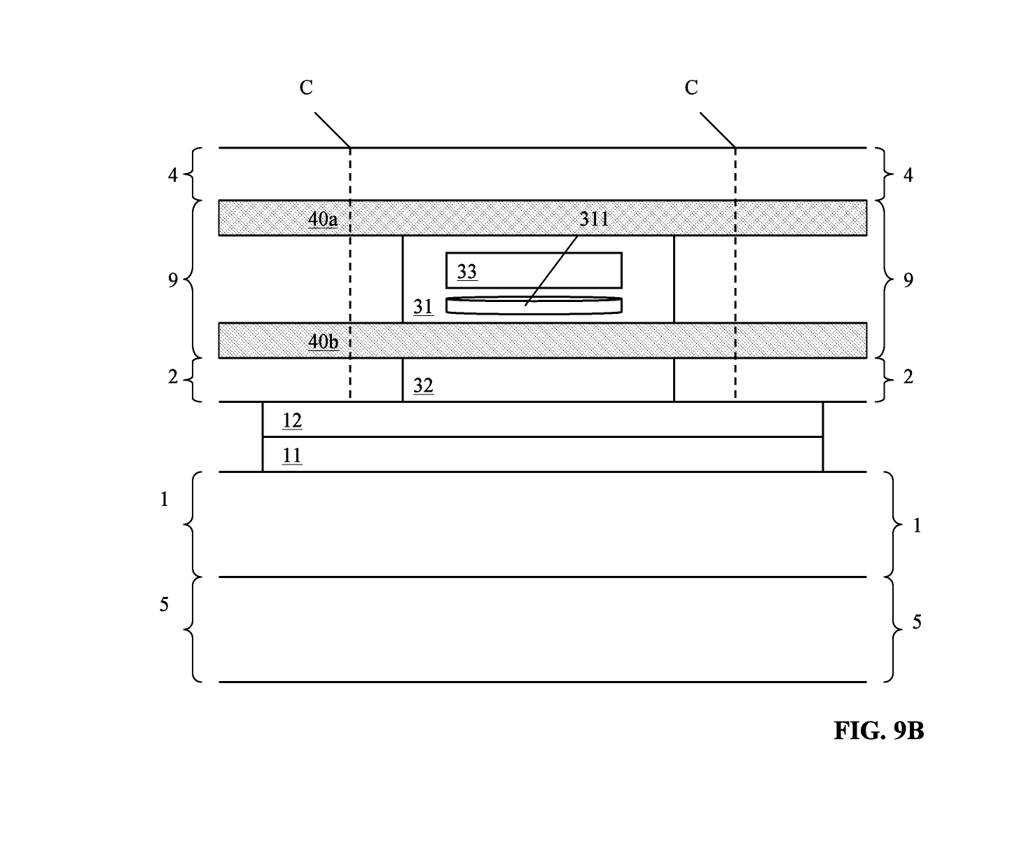

FIG. 9A shows a cross-sectional view of a plastic card prelaminate produced by a method according to an embodiment of the invention. A first PVC sheet 1 is partly covered with a release layer 12 comprising silicone applied via, e.g., screen printing. Several through-holes are formed in a second PVC sheet 2 and the second PVC sheet 2 is placed on the release layer 12 so that each through-hole is covered by the release layer 12.

The composite structure includes an inlay 31. The inlay 31 comprises a polyester layer (e.g., Melinex® by DuPont Teijin Films, USA) and includes an RFID chip and antenna 311. An absorber layer 33 is placed on top of the RFID chip and antenna 311 in the inlay 31. The inlay 31 is included in a sheet 9 having two cover layers 40a and 40b of a unidirectional thermally expansive material positioned on the top and the bottom of the inlay 31. The sheet 9 is placed on top of the second PVC sheet 2.

To manufacture plastic cards from the plastic card prelaminate, a third PVC sheet 4 is placed adjacent to the inlays 31 of the plastic card prelaminate, as shown in FIG. 9B. A fourth PVC sheet 5 is placed adjacent to the first PVC sheet 1. The third PVC sheet 4, the fourth PVC sheet 5 and the plastic card prelaminate including the sheet 9 having the inlay 31 and cover layers 40a and 40b, the second PVC sheet 2, the release layer 12, the adhesive layer 11, and the first PVC sheet 1 are laminated. Any standard laminating techniques known in the art can be used, resulting in a laminated sheet that has a thickness of 0.76±0.08 mm. Plastic cards are cut from the resulting laminated sheet so that each plastic card contains one RFID chip and antenna 311. Each resulting plastic card is pre-cut along cut lines C through the third PVC layer 4, the sheet 9 including the cover layers 40a and 40b, and the second PVC sheet 2 to define a phone sticker.

While FIGS. 8A, 8B, 9A and 9B illustrate particular applications of the unidirectional thermally expansive material, other configurations can also be formed without departing from the spirit and scope of the invention. In general, the material can be applied to any combination of one or more of the other layers.

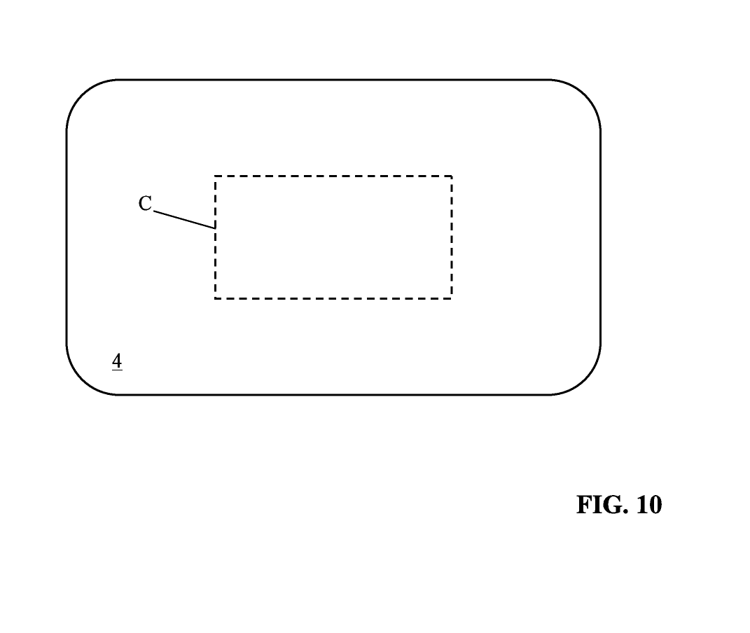

FIG. 10 shows a top view on a plastic card produced from a plastic card prelaminate according to any of the embodiments of the invention. Cut lines (denoted using reference character C in FIG. 10) in the third PVC sheet 4 define a phone sticker that can be separated from the plastic card by punching it out. This type of plastic card is easy to produce. However, such a type of plastic card has a risk of deformation.

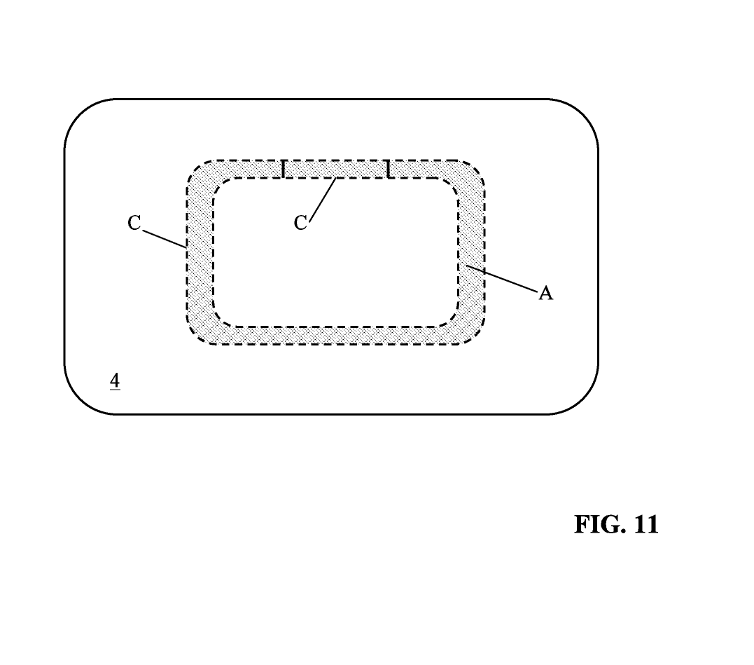

FIG. 11 shows a top view of a plastic card produced from a plastic card prelaminate according to any of the embodiments of the invention using a more preferred method of plastic card production. In an area (e.g., the shaded area denoted by reference character A in FIG. 11), plastic card material is removed to produce a recess between the phone sticker and the remaining plastic material. The remaining plastic material that connects the phone sticker to the rest of the plastic card comprises two cut lines (denoted using reference character C in FIG. 11) spaced away from each other. This type of plastic card pre-cut results in a lower risk of plastic card bending. In particular, having two cut lines C result in less bending than having only one cut-line C. The resulting plastic card is flat and on a level plane.

The method according to the invention results in a plastic card prelaminate that allows production of a plastic card including a mobile phone sticker or a metal-compatible contactless sticker that is fully personalized and has a thickness of about 550 μm, which allows sufficient flexibility. Moreover, the thickness of the plastic card is within the relevant ISO-norm. The techniques described herein benefit local card manufacturers, since the techniques provide the manufacturers with more efficient, cost-effective, and thinner products.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof The foregoing embodiments are therefore to be considered in all respects illustrative rather than limiting of the invention described herein.

What is claimed is:

1. A method for manufacturing a plastic card prelaminate, the method comprising:
providing a first plastic sheet having a release layer bonded to the first plastic sheet via an adhesive layer;
providing at least one composite structure comprising a plastic layer including at least one electronic element;
providing a second plastic sheet on top of the first plastic sheet;
forming at least one through-hole in the second plastic sheet, wherein each through-hole is smaller than the release layer bonded to the first plastic sheet; and
positioning one composite structure in each through-hole.

2. The method according to claim 1, wherein each of the plastic layer, the first plastic sheet and the second plastic sheet comprises a material selected from the group consisting of polyvinyl chloride, polyethylene terephthalate, polyester and acrylonitrile-butadiene-styrene.

3. The method according to claim 1, wherein the plastic layer consists of a transparent material.

4. The method according to claim 1, wherein the electronic element is a radio frequency identification (RFID) chip and antenna or a near field communication (NFC) chip and antenna.

5. The method according to claim 1, wherein the adhesive layer comprises a pressure sensitive adhesive.

6. The method according to claim 1, the composite structure further comprising an absorber layer positioned adjacent to the plastic layer, the absorber layer comprising a material that reduces Eddy currents.

7. The method according to claim 6, wherein the material that reduces Eddy currents is a magnetically soft and/or high permeable material selected from the group consisting of rare earth metals, ferrites, cobalt/neodymium compounds and combinations thereof

8. The method according to claim 6, wherein the material that reduces Eddy currents is applied to the plastic layer via screen printing.

9. The method according to claim 1, the composite structure further comprising:
a first cover layer of a unidirectional thermally expansive material positioned on top of the plastic layer, and
a second cover layer of the unidirectional thermally expansive material positioned below the plastic layer.

10. The method according to claim 9, the composite structure further comprising an absorber layer positioned between the plastic layer and the second cover layer, the absorber layer comprising a material that reduces Eddy currents.

11. The method of claim 9, the composite structure further comprising an absorber layer positioned below the second cover layer, the absorber layer comprising a material that reduces Eddy currents.

12. The method according to claim 1, wherein the release layer comprises a material selected from the group consisting of silicones and teflon.

13. The method according to claim 1, wherein one surface of the first plastic sheet is coated with the release layer via screen printing.

14. The method according to claim 1, wherein the adhesive force between the second adhesive layer and the release layer is greater than the adhesive force between the plastic layer and the release layer.

15. The method according to claim 1, wherein the composite structure includes the release layer

16. The method according to claim 1, the composite structure further comprising a contact adhesive layer positioned below the plastic layer.

17. The method according to claim 1, wherein a third plastic sheet is positioned between the plastic layer and the release layer.

22. A plastic card prelaminate comprising a first plastic sheet having a release layer bonded to the first plastic sheet via an adhesive layer;
a second plastic sheet on top of the first plastic sheet; and
at least one composite structure in at least one through-hole in the second plastic sheet, the composite structure comprising a plastic layer including at least one electronic element, wherein each through-hole is smaller than the release layer bonded to the first plastic sheet.

23. The plastic card prelaminate according to claim 22, wherein each of the plastic layer, the first plastic sheet, and the second plastic sheet comprises a material selected from the group consisting of polyvinyl chloride, polyethylene terephthalate, polyester and acrylonitrile-butadiene-styrene.

24. The plastic card prelaminate according to claim 22, wherein the plastic layer consists of a transparent material.

25. The plastic card prelaminate according to claim 22, wherein the electronic element is a radio frequency identification (RFID) chip and antenna or a near field communication (NFC) chip and antenna.

26. The plastic card prelaminate according to claim 22, wherein the adhesive layer comprises a pressure sensitive adhesive.

27. The plastic card prelaminate according to claim 22, the composite structure further comprising an absorber layer positioned below the plastic layer, the absorber layer comprising a material that reduces Eddy currents.

28. The plastic card prelaminate according to claim 27, wherein the material that reduces Eddy currents is a magnetically soft and/or high permeable material selected from the group consisting of rare earth metals, ferrites, cobalt/neodymium compounds and combinations thereof

29. The plastic card prelaminate according to claim 27, wherein the material that reduces Eddy currents is applied to the plastic layer via screen printing.

30. The plastic card prelaminate according to claim 22, the composite structure further comprising a first cover layer on top of the plastic layer comprising a unidirectional thermally expansive material and a second cover layer below the plastic layer comprising the unidirectional thermally expansive material.

30. The plastic card prelaminate according to claim 29, the composite structure further comprising an absorber layer positioned between the plastic layer and the second cover layer, the absorber layer comprising a material that reduces Eddy currents.

31. The plastic card prelaminate according to claim 29, the composite structure further comprising an absorber layer positioned below the second cover layer, the absorber layer comprising a material that reduces Eddy currents.

32. The plastic card prelaminate according to claim 22, wherein the release layer comprises a material selected from the group consisting of silicones and teflon.

33. The plastic card prelaminate according to claim 22, wherein the adhesive force between the adhesive layer and the release layer is greater than the adhesive force between the plastic layer and the release layer.

34. The plastic card prelaminate according to claim 22, wherein the composite structure includes the release layer

35. The plastic card prelaminate according to claim 22, the composite structure further comprising a contact adhesive layer positioned below the plastic layer.

36. The plastic card prelaminate according to claim 22, wherein a third plastic sheet is positioned between the plastic layer and the release layer.

37. A method for manufacturing a plastic card, the method comprising:
providing a plastic card prelaminate comprising:
a first plastic sheet having a release layer bonded to the first plastic sheet via an adhesive layer;
a second plastic sheet on top of the first plastic sheet;
at least one composite structure in at least one through-hole in the second plastic sheet, the composite structure comprising a plastic layer including at least one electronic element, wherein each through-hole is smaller than the release layer bonded to the first plastic sheet;
positioning a third plastic sheet adjacent to the plastic layer and the second plastic sheet;
positioning a fourth plastic sheet adjacent to the first plastic sheet;
laminating the first plastic sheet, the second plastic sheet, the composite structure, the fourth plastic sheet and the fifth plastic sheet to obtain a laminated sheet; and
cutting the plastic card from the laminated sheet.

38. The method according to claim 37, the composite structure further comprising an absorber layer positioned below the plastic layer, the absorber layer comprising a material that reduces Eddy currents.

39. The method according to claim 37, the composite structure further comprising a first cover layer of a unidirectional thermally expansive material positioned on top of the plastic layer, and a second cover layer of the unidirectional thermally expansive material positioned below the plastic layer.

40. The method according to claim 39, the composite structure further comprising an absorber layer positioned between the plastic layer and the second cover layer, the absorber layer comprising a material that reduces Eddy currents.

41. The method of claim 39, the composite structure further comprising an absorber layer positioned below the second cover layer, the absorber layer comprising a material that reduces Eddy currents.

42. A plastic card manufactured according to the method of claim 37.

43. The plastic card according to claim 42, wherein the plastic card is pre-cut in an area defining a phone sticker or a metal-compatible contactless sticker.

44. The plastic card according to claim 42, wherein the phone sticker is surrounded by a pre-cut area, all plastic card material is removed in a first part of the pre-cut area, and a second part of the pre-cut area comprises at least one cut-line extending from the fourth plastic layer to the release layer.

45. The plastic card according to claim 42, wherein the second pre-cut area comprises two cut-lines.

46. A phone sticker obtainable by separating the phone sticker from a plastic card according to claim 42.
